(19) United States
(12) Patent Application Publication
(10) Pub. No.: US 2026/0046332 A1
(43) Pub. Date: Feb. 12, 2026

(54) ACCELERATOR STATE CONTROL DEVICE, ACCELERATOR STATE CONTROL SYSTEM, ACCELERATOR STATE CONTROL METHOD AND PROGRAM

(71) Applicant: NTT, Inc., Tokyo (JP)

(72) Inventors: Shogo SAITO, Tokyo (JP); Ko NATORI, Tokyo (JP); Ikuo OTANI, Tokyo (JP); Kei FUJIMOTO, Tokyo (JP)

(73) Assignee: NTT, Inc., Tokyo (JP)

(21) Appl. No.: 19/100,138

(22) PCT Filed: Aug. 2, 2022
(86) PCT No.: PCT/JP2022/029707

§ 371 Date: Jan. 31, 2025

(51) Int. Cl. H04L 67/101

(52) U.S. Cl. CPC H04L 67/101

(57) ABSTRACT

An accelerator state control device includes a plurality of accelerators having different processing performance, and controls a state of the accelerators when arithmetic processing is performed by offloading specific processing of an application to the accelerators. The accelerator state control device includes: when data in which different processing deadlines are mixed is input, an arithmetic device performance collection/recording unit that collects and records performance information of the accelerators; a traffic amount/processing deadline prediction unit that predicts a traffic amount and a processing deadline; and an arithmetic device allocation determination unit that obtains a data amount corresponding to the processing deadline, and determines an accelerator that satisfies the performance on the basis of the data amount.

### TECHNICAL FIELD

The present invention relates to an accelerator state control device, an accelerator state control system, an accelerator state control method, and a program.

### BACKGROUND ART

Workloads that processors are good at (i.e., have high processing capability for) are different depending on the types of processors. Central processing units (CPUs) have high versatility, but are not good at (i.e., have low processing capability for) operating a workload having a high degree of parallelism, whereas accelerators (hereinafter, appropriately referred to as ACCs), such as a field programmable gate array (FPGA)/(hereinafter, “/” denotes “or”) a graphics processing unit (GPU)/an application specific integrated circuit (ASIC), can operate the workload at high speed with high efficiency. Offload techniques, which improve overall operation time and operation efficiency by combining those different types of processors and offloading the workload that the CPUs are not good at to the ACCs to operate the workload, has been increasingly utilized.

In a virtual radio access network (vRAN) or the like, in a case where performance is insufficient and a requirement cannot be satisfied only by a CPU, a part of processing is offloaded to an accelerator capable of high-speed operation such as an FPGA or a GPU.

Representative examples of a specific workload offloaded to the ACC include encoding/decoding processing (forward error correction (FEC) processing) in the vRAN, audio and video media processing, and encryption/decryption processing.

In a computer system, a configuration may be adopted in which hardware (CPU) corresponding to general-purpose processing and hardware (accelerator) specialized for specific arithmetic are mounted on a computer (hereinafter, an accelerator-equipped server), and a part of arithmetic processing is offloaded from a general-purpose processor on which software operates to the accelerator.

With the progress of cloud computing, it is becoming more common to offload a part of processing including a large amount of arithmetic operation from a client machine deployed at a user site to a server at a remote site (such as a data center located in the vicinity of a user) via a network (NW) in order to simplify the configuration of the client machine.

FIG. 14 is a diagram illustrating a computer system. Arrows in FIG. 14 indicate a flow of data.

As illustrated in FIG. 14, a server 50 includes a CPU 11, a plurality of accelerators (high performance) 12-1 and accelerators (low performance) 12-2 having different processing capabilities, and an input/output unit 13 on hardware 10, and includes an application (hereinafter, referred to as APL as appropriate) 1 of software 20 that operates on the CPU 11 on the server 50.

The application 1 calls a function group (API) defined as a standard, and offloads partial processing to the accelerator 12.

In the present specification, a configuration in which a plurality of accelerators having different processing capabilities can be used is referred to as a “performance hetero configuration”. In FIG. 14, there is a hetero configuration of a high-throughput accelerator (high performance) 12-1 and a low-throughput accelerator (low performance) 12-2. When the accelerator (high performance) 12-1 and the accelerator (low performance) 12-2 are not distinguished from each other, they are collectively referred to as the accelerator 12.

The accelerator 12 is a calculation accelerator device such as an FPGA/GPU. The accelerator 12 includes an accelerator operation circuit or a program, and performs an operation using the accelerator operation circuit or the program.

The input/output unit 13 receives and outputs input data.

The server 50 receives input data from the outside, performs arithmetic processing inside the server, and then outputs the input data to the outside.

The server 50 has a premise for the input data.
(1) An amount of input data varies in time series. An example thereof is sudden traffic at the time of occurrence of an event in a radio access network (RAN).
(2) The input data has different processing deadlines. For example, the processing deadline is determined in ultra-reliable and low latency communications (URLLC) traffic (ultra-low latency) or enhanced mobile broadband (eMBB) traffic (low to medium latency requirements) in 5G NR. In addition, there is a mixture of URLLC traffic (ultra-low latency) and eMBB traffic (low to medium latency requirements) in 5G NR.

FIG. 15 is a diagram illustrating a variation in the amount of input data of the server 50 and the breakdown of the processing deadline. A solid line in FIG. 15 indicates the total traffic amount, and a broken line in FIG. 15 indicates the traffic amount with a short processing deadline. In addition, a portion where the traffic amount protrudes in FIG. 15 is sudden traffic. As an example of the sudden traffic, the sudden traffic is caused (for example, a firework event or the like) by an event or the like in which traffic in a partial area increases in the RAN system.

In the server 50, requirements for satisfying the processing deadline of each input data with respect to the input data of which the amount varies in time series are as follows.

### Requirement 1: [Satisfaction of Processing Deadline of Each Data]

In input data in which different processing deadlines are mixed, processing in the server is completed within a certain time from the input so as to satisfy each deadline.

### Requirement 2: [Scalability]

The processing performance can be scaled (i.e., extended and reduced) according to the amount of input traffic.

In the server equipped with an accelerator, there are the following techniques for allocating an accelerator to traffic of a certain amount and a certain processing deadline ratio.

### Allocation of Accelerator for Traffic of Rate of Processing Deadline

First, a technology of fixedly allocating an accelerator to traffic at a processing deadline rate in an accelerator-equipped server will be described (Non Patent Literature 1).

### Existing Technology 1

FIG. 16 is a diagram illustrating static accelerator assignment in Existing Technology 1 (Non Patent Literature 1). The same components as those in FIG. 14 are denoted by the same reference signs.

As illustrated in FIG. 16, a server 50 includes a CPU 11, a plurality of accelerators (high performance) 12-1 and accelerators (low performance) 12-2 having different processing capabilities on hardware 10, and includes an application 1 of software 20 that operates on the CPU 11 on the server 50.

In the server 50, an accelerator is fixedly allocated to traffic of a certain amount and a certain processing deadline ratio (double line a in FIG. 16). In FIG. 16, the accelerator (high performance) 12-1 is fixedly allocated to the application 1.

The processing deadline of each input data is designed on the assumption of a constant value.

Existing Technology 1 has a feature that the following requirements are satisfied/not satisfied.

### Requirement 1: Satisfaction of Processing Deadline of Each Data

Since the processing deadline of each input data is designed on the premise of a constant value, the input data does not exceed the constant value, and thus “satisfaction of the processing deadline of each data” is conditionally satisfied.

### Requirement 2: Scalability

The resource amount is constant and does not satisfy the scale-out/scale-in “scalability” of the accelerator.

FIG. 17 is a diagram illustrating a variation in the amount of input data in Existing Technology 1. A solid line in FIG. 17 indicates the total traffic amount, and a broken line in FIG. 17 indicates the traffic amount with which the system can ensure responsiveness.

As illustrated in FIG. 17, the traffic amount (broken line in FIG. 17) with which the system can ensure responsiveness is constant.

In Existing Technology 1, accelerators are statically allocated in accordance with the maximum amount of traffic at the normal time. Therefore, when the amount of input data suddenly increases, the processing capacity becomes insufficient (a white arrow b in FIG. 17).

Next, a technology for achieving the scale of ACC by a function proxy in the server equipped with an accelerator will be described (Non Patent Literature 1).

### Existing Technology 2

FIG. 18 is a diagram illustrating implementation of the scale of ACC by the function proxy of Existing Technology 2. The same components as those in FIG. 14 are denoted by the same reference signs.

As illustrated in FIG. 18, in the server 50, the software 20 includes proxy software 2. The proxy software 2 includes a function proxy 3 and an accelerator I/O control unit 4 that performs input/output control for the accelerator by the function proxy 3.

The server 50 dynamically allocates the accelerator by scale-out using the function proxy 3 of the ACC usage function (double line c in FIG. 18). In FIG. 18, the proxy software 2 dynamically allocates processing of the application 1 to an accelerator (high performance) 12-1 or an accelerator (low performance) 12-2.

Existing Technology 2 has a feature that the following requirements are satisfied/not satisfied.

### Requirement 1: Satisfaction of Processing Deadline of Each Data

Since the ACC performance is not considered, the responsiveness is not satisfied when the ratio of the traffic requiring the low-latency processing increases among the traffic.

### Requirement 2: Scalability

Scale-out according to the traffic amount is possible.

FIG. 19 is a diagram illustrating processing deadlines in Existing Technology 2. A solid line in FIG. 19 indicates a total traffic amount, a broken line in FIG. 19 indicates a traffic amount with a short processing deadline, and a double line in FIG. 19 indicates a traffic amount with which responsiveness can be secured.

As indicated by a white arrow c in FIG. 19, there is a moment at which the allocated ACC cannot meet the deadline. Particularly, the responsiveness is not satisfied when the ratio of the traffic requiring the low-latency processing increases.

### CITATION LIST

### Non Patent Literature

Non Patent Literature 1: “16.2. PCI Device Assignment with SR-IOV Devices Red Hat Enterprise Linux 7 | Red Hat Customer Portal”, [online] [Retrieved on Jul. 6, 2022], the Internet <URL: https://access.redhat.com/documentation/ja-jp/red_hat_enterprise linux/7/html/virtualization_deploymen t_and_administration_guide/sect-pci_devices-pci_passthrough>

### SUMMARY OF INVENTION

### Technical Problem

Existing technologies 1 and 2 have the following problems.

Existing Technology 1 (static allocation) has a problem that the resource amount of the accelerator is constant and <Requirement 2: Scalability> is not satisfied.

Existing Technology 2 (scale-out by a function proxy) does not consider a difference in performance of each accelerator, and thus has a problem that <Requirement 1: Satisfaction of Processing Deadline of Each Data> is not satisfied.

The present invention has been made in view of such a background, and an object of the present invention is to achieve reduction of arithmetic operation resources to be used while securing responsiveness according to a variation in the data amount corresponding to each processing deadline in an accelerator-equipped server having a hetero configuration.

### Solution to Problem

In order to solve the above problems, the present invention provides an accelerator state control device that includes a plurality of accelerators having different processing performance, and controls a state of the accelerators when arithmetic processing is performed by offloading specific processing of an application to the accelerators. Herein, the accelerator state control device includes: when data in which different processing deadlines are mixed is input, a recording unit that collects and records performance information of the accelerator; a prediction unit that predicts a traffic amount and a processing deadline after a lapse of a predetermined time from a ratio between current and past traffic amounts and a processing deadline; and a determination unit that obtains a data amount corresponding to the processing deadline on the basis of the traffic amount and the processing deadline after the lapse of the predetermined time predicted by the prediction unit and the performance of the accelerator recorded in the recording unit, and determines an accelerator that satisfies the performance on the basis of the data amount.

### Advantageous Effects of Invention

According to the present invention, it is possible to reduce operation resources to be used while ensuring responsiveness according to a variation in the data amount corresponding to each processing deadline.

### BRIEF DESCRIPTION OF DRAWINGS

FIG. 1 is a schematic configuration diagram of an accelerator state control system according to an embodiment of the present invention.

FIG. 2 is a schematic configuration diagram of the accelerator state control system according to the embodiment of the present invention.

FIG. 3 is a schematic configuration diagram illustrating a variation in arrangement of an accelerator state control device of the accelerator state control system according to the embodiment of the present invention.

FIG. 4 is a diagram illustrating an example of a DB table of the accelerator state control device of the accelerator state control system according to the embodiment of the present invention.

FIG. 5 is a diagram illustrating an example of a latency table of the accelerator state control device of the accelerator state control system according to the embodiment of the present invention.

FIG. 6 is a diagram illustrating a configuration example of an ACC function/argument data packet of the accelerator state control device of the accelerator state control system according to the embodiment of the present invention.

FIG. 7 is a diagram illustrating a calculation example of an available ACC list from the Host-1 of the accelerator state control system according to the embodiment of the present invention.

FIG. 8 is a flowchart illustrating operation 1 of an arithmetic device allocation determination unit and a traffic amount/processing deadline prediction unit of the accelerator state control device of the accelerator state control system according to the embodiment of the present invention.

FIG. 9 is a flowchart illustrating operation 2 of an arithmetic device allocation determination unit and a traffic amount/processing deadline prediction unit of the accelerator state control device of the accelerator state control system according to the embodiment of the present invention.

FIG. 10 is a flowchart illustrating arithmetic device allocation (ACC allocation) of the accelerator state control device of the accelerator state control system according to the embodiment of the present invention.

FIG. 11A is a flowchart illustrating input data processing of the accelerator state control system according to the embodiment of the present invention.

FIG. 11B is a flowchart illustrating input data processing of the accelerator state control system according to the embodiment of the present invention.

FIG. 11C is a flowchart illustrating input data processing of the accelerator state control system according to the embodiment of the present invention.

FIG. 12A is a flowchart illustrating input data processing of the accelerator state control system according to the embodiment of the present invention.

FIG. 12B is a flowchart illustrating input data processing of the accelerator state control system according to the embodiment of the present invention.

FIG. 12C is a flowchart illustrating input data processing of the accelerator state control system according to the embodiment of the present invention.

FIG. 13 is a hardware configuration diagram illustrating an example of a computer that implements functions of the accelerator state control system according to the embodiment of the present invention.

FIG. 14 is a diagram illustrating a computer system.

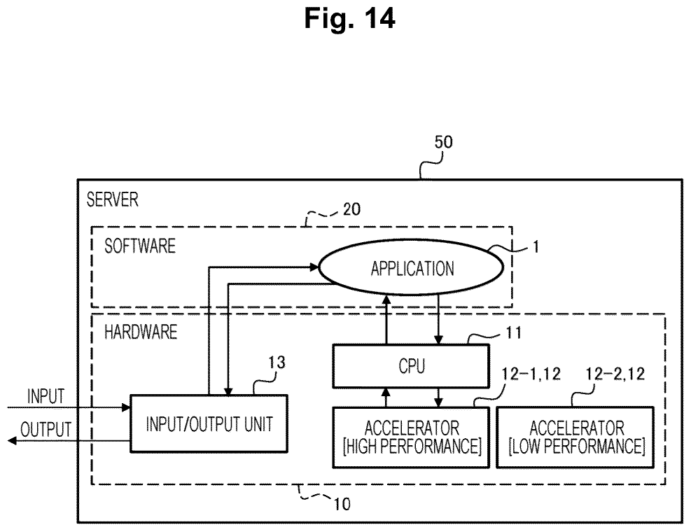

FIG. 15 is a diagram illustrating a variation in the amount of input data of the server and the breakdown of the processing deadline.

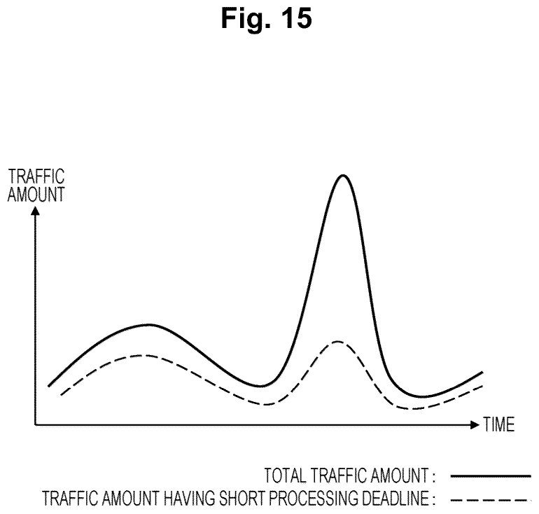

FIG. 16 is a diagram illustrating static accelerator allocation in Existing Technology 1 (Non Patent Literature 1).

FIG. 17 is a diagram illustrating a variation in the amount of input data in Existing Technology 1.

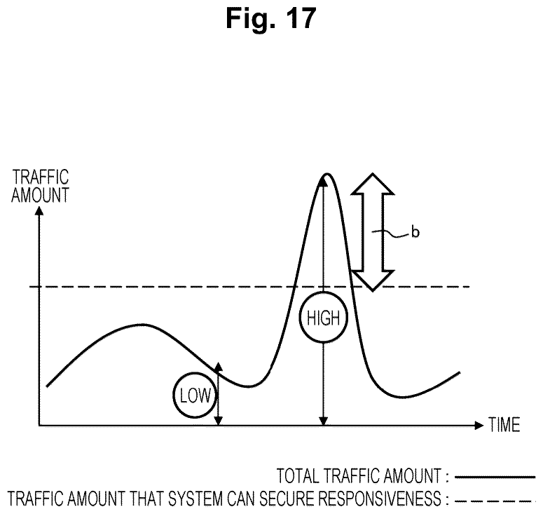

FIG. 18 is a diagram illustrating implementation of the scale of ACC by the function proxy of Existing Technology 2.

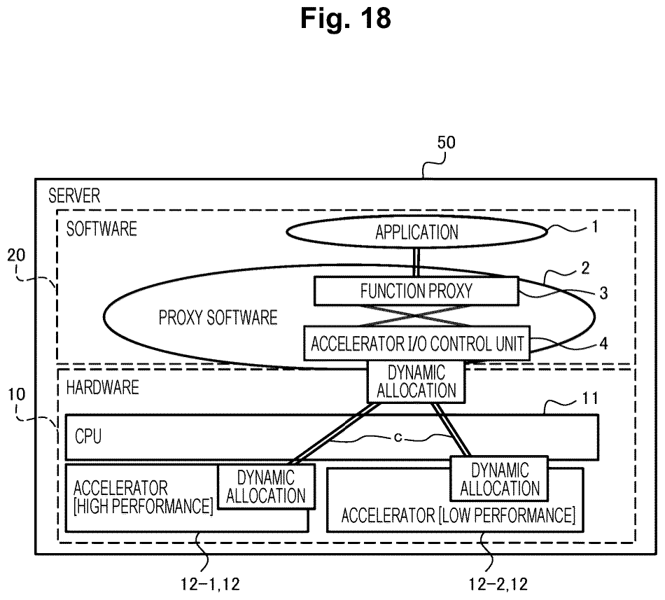

FIG. 19 is a diagram illustrating processing deadlines in Existing Technology 2.

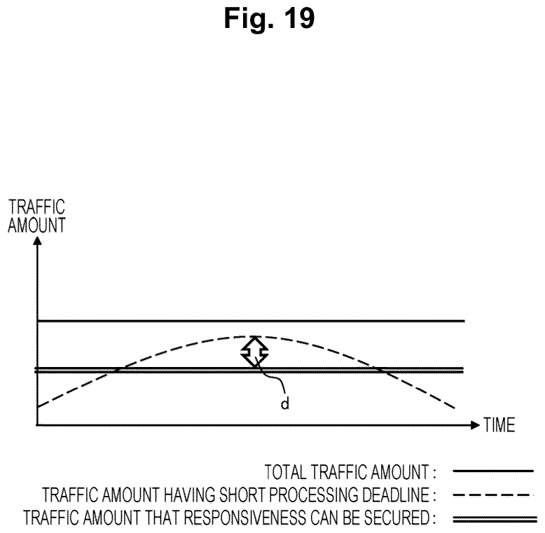

### DESCRIPTION OF EMBODIMENTS

Hereinafter, an accelerator state control system and the like in a mode for carrying out the present invention (hereinafter, referred to as “present embodiment”) will be described with reference to the drawings.

### Embodiment

### Overview

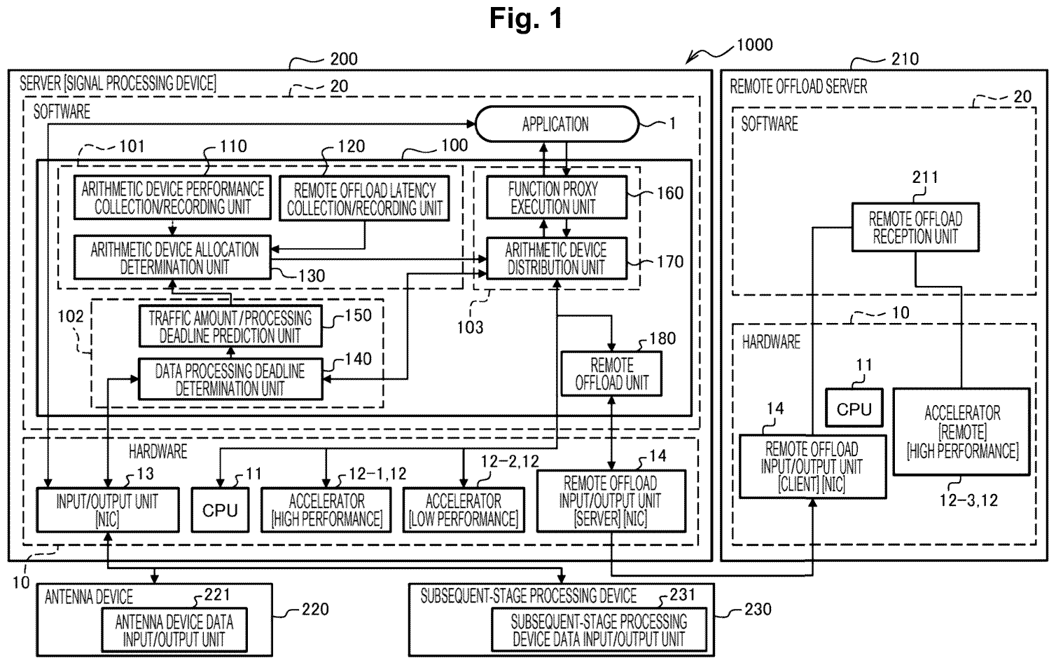

FIG. 1 is a schematic configuration diagram of an accelerator state control system according to an embodiment of the present invention. FIG. 1 illustrates an example of application to a Look-Aside type accelerator “explicitly offload data obtained via an input/output unit such as an NIC from a CPU to an accelerator”. In the Look-Aside type, the CPU offloads a part of the processing to the accelerator. In the Look-Aside accelerator, the CPU manages the state.

As illustrated in FIG. 1, the accelerator state control system 1000 includes a server 200 ([signal processing device]), a remote offload server 210, an antenna device 220, and a subsequent-stage processing device 230.

In addition, the accelerator state control system 1000 includes an accelerator state control device 100 that controls a state of the accelerator 12 when specific processing of the application 1 is offloaded to the accelerator 12 and arithmetic processing is performed.

### Server 200

The server 200 is a distributed unit in 5G signal processing.

The server 200 includes hardware (HW) 10 and software 20.

### Hardware 10

The hardware 10 includes a central processing unit (CPU) 11, a plurality of accelerators (high performance) 12-1 having different processing capabilities, an accelerator (low performance) 12-2, an accelerator 12, an input/output unit 13, and a remote offload input/output unit (client) (NIC) 14.

### CPU11

The CPU 11 executes processing of the application 1 and executes software of each functional unit in the server 200.

### Accelerator 12

The accelerator 12 is a calculation accelerator device such as an FPGA/GPU. The accelerator 12 is an arithmetic unit mounted on the server 200 and specialized for specific processing. As a form of being connected to the CPU 11 via a bus, there are forms such as an ASIC mounted accelerator, an FPGA mounted accelerator, and a GPU.

In the present embodiment, “performance hetero configuration” in which a plurality of accelerators having different processing capacities can be used is used. The plurality of accelerators having different processing capacities include the accelerator (high performance) 12-1 and the accelerator (low performance) 12-2.

### Input/Output Unit 13>

The input/output unit 13 is an input/output mechanism such as a network interface card (NIC), and performs data input/output with an external device (the antenna device 220 or the subsequent-stage processing device 230). In addition, the input/output unit 13 has an interface that notifies the application 1 of the current data input amount.

### Remote Offload Input/Output Unit 14

The remote offload input/output unit (client) (NIC) 14 and the remote offload input/output unit (server) (NIC) 14 are network interface devices represented by NIC and the like, and are functional units that perform communication between servers.

### Software 20

The software 20 includes an application 1 and an accelerator state control device 100 that controls the state of the accelerator.

### Application 1

The application 1 is a program that performs signal processing and operates on the CPU 11. For dedicated processing that is not suitable for the CPU, such as some parallel arithmetic processing, offload is performed to the accelerator 12 (accelerator (high performance) 12-1, the accelerator (low performance) 12-2, and the accelerator (high performance) 12-3). For example, the application 1 calls a function group (API) defined as a standard, and offloads partial processing to the accelerator 12.

### Input/Output

The application 1 receives processing target data from the input/output unit 13 as an input. As an output, the arithmetic operated data is passed to the input/output unit 13.

### Modification

In the present embodiment, the input/output unit 13, the CPU 11, and the accelerator 12 are separated as hardware, but may be in the form of dedicated hardware in which these are integrated.

In addition, as in the present embodiment, in addition to a so-called Look-Aside type accelerator application form “explicitly offload data obtained via the input/output unit 13 such as an NIC from the CPU 11 to the accelerator 12”, a so-called In-line type accelerator application form in which processing is completed in the same hardware after data is received by the NIC by hardware in which the “NIC accelerator CPU 11” is integrated may be used.

### Accelerator State Control Device 100

The accelerator state control device 100 includes an arithmetic device performance collection/recording unit 110, a remote offload latency collection and recording unit 120 (latency recording unit), an arithmetic device allocation determination unit 130, a data processing deadline determination unit 140, a traffic amount/processing deadline prediction unit 150, a function proxy execution unit 160, an arithmetic device distribution unit 170, and a remote offload unit 180.

The arithmetic device performance collection/recording unit 110, the remote offload latency collection and recording unit 120, and the arithmetic device allocation determination unit 130 constitute an allocation determination function unit 101. The data processing deadline determination unit 140 and the traffic amount/processing deadline prediction unit 150 constitute a prediction function unit 102. The function proxy execution unit 160 and the arithmetic device distribution unit 170 constitute a distribution function unit 103.

### Arithmetic Device Performance Collection/Recording Unit 110

The arithmetic device performance collection/recording unit 110 collects and records the performance of each arithmetic device (CPU 11, accelerator (high performance) 12-1, accelerator (low performance) 12-2). The performance information includes throughput, processing latency, and power consumption.

The arithmetic device performance collection/recording unit 110 stores accelerator information of each host by static setting input by the operator. The arithmetic device performance collection/recording unit 110 has each piece of performance information on the basis of an identifier for uniquely identifying each arithmetic device.

### Configuration Example

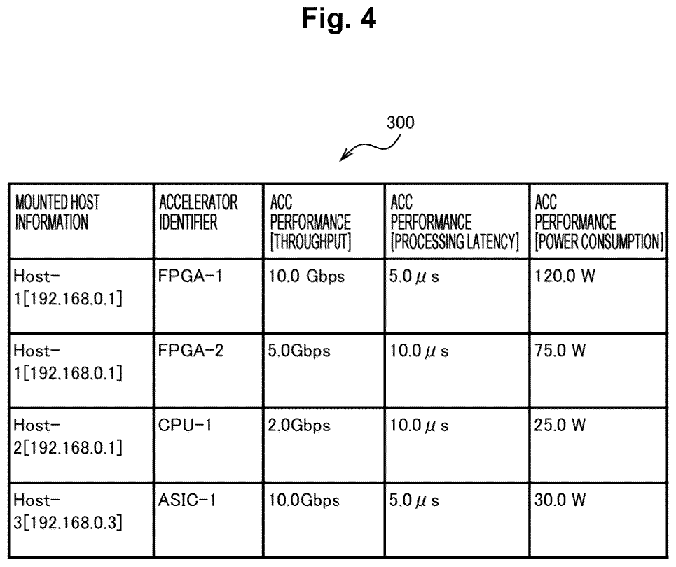

A database configuration example of the recording device is illustrated in an example of a DB table 300 (FIG. 4) of the arithmetic device performance collection/recording unit 110.

### Input/Output

The arithmetic device performance collection/recording unit 110 receives a required accelerator condition such as specific performance or an identifier of a host as an input, and responds with a list of accelerators that meet the input condition as an output.

### Modification

The arithmetic device performance collection/recording unit 110 may automatically collect information using an external configuration management tool or a command for acquiring device configuration information.

### Remote Offload Latency Collection/Recording Unit 120

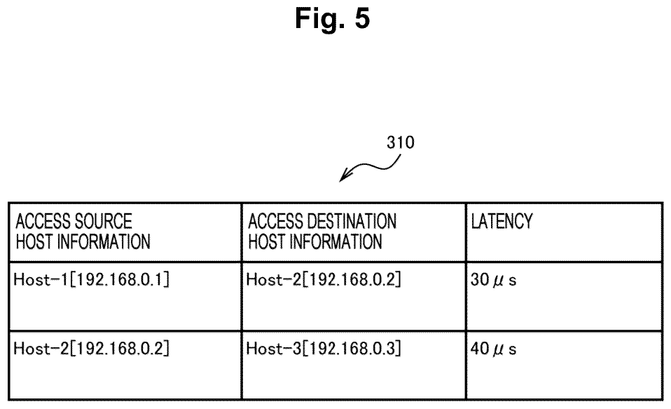

The remote offload latency collection/recording unit 120 collects and records communication latency (latency) that occurs in remote offloading between signal processing devices (here, from the server 200, the remote offload server 210 that is another server) equipped with accelerators. The remote offload latency collection/recording unit 120 holds the communication latency between the remote offload server 210 and the server 200 that is an offload source in a latency table 310 illustrated in FIG. 5 to be described later.

### Configuration Example

A database configuration example of the recording device is illustrated in an example of a DB table 300 of the arithmetic device performance collection/recording unit 110.

### Input/Output

The remote offload latency collection/recording unit 120 receives, as an input, host information of a specific combination, and calculates, as an output, a latency from the host information of the combination received by the input, and makes a response.

### Modification

The remote offload latency collection/recording unit 120 may automatically collect information and update latency. Specifically, a latency measuring function (not illustrated) mounted on each host may measure a communication delay to another host at a constant cycle and update information in the remote offload latency collection/recording unit 120.

### Arithmetic Device Allocation Determination Unit 130

The arithmetic device allocation determination unit 130 obtains the data amount corresponding to the processing deadline on the basis of the traffic amount and the processing deadline after the lapse of the predetermined time predicted by the traffic amount/processing deadline prediction unit 150 and the performance information of the accelerator 12 recorded in the arithmetic device performance collection/recording unit 110, and determines the accelerator satisfying the performance on the basis of the data amount.

The arithmetic device allocation determination unit 130 determines an arithmetic device that satisfies performance on the basis of the traffic amount and the processing deadline after a lapse of a certain time, and allocates the arithmetic device to the arithmetic device distribution unit 170.

The arithmetic device allocation determination unit 130 receives the traffic amount after a lapse of a certain time and the processing deadline from the traffic amount/processing deadline prediction unit 150. The arithmetic device allocation determination unit 130 makes an inquiry to the arithmetic device performance collection/recording unit 110 and the remote offload latency collection/recording unit 120 on the basis of the performance requirement, and obtains a list of accelerators. The arithmetic device allocation determination unit 130 obtains a list of local accelerators and accelerators of remote offload destinations on the basis of these pieces of information.

### Configuration Example

For the accelerator 12 of the remote offload destination, the offload latency is added to the accelerator processing time. From the above list, a combination of accelerators with the lowest power consumption while satisfying the performance is selected and provided in notification to the arithmetic device distribution unit 170.

### Input/Output

The arithmetic device allocation determination unit 130 receives, as an input, the traffic amount and the ratio of the processing deadline after a lapse of a certain time, and responds to, as an output, a list of accelerators matching the input condition.

### Modification

The arithmetic device allocation determination unit 130 may automatically collect information using an external configuration management tool or a command for acquiring device configuration information.

### Data Processing Deadline Determination Unit 140

The data processing deadline determination unit 140 identifies the processing deadline of each input data and then notifies each functional unit of the processing deadline.

The data processing deadline determination unit 140 receives input data from the input/output unit 13, refers to header information at the head of the input data, and identifies a processing deadline. In an example in the RAN, a processing deadline of corresponding data is identified by referring to a corresponding enhanced common public radio interface (eCPRI) protocol header and identifying session information.

### Input/Output

The data processing deadline determination unit 140 receives input data from the input/output unit 13 as an input, and notifies the traffic amount/processing deadline prediction unit 150 of the amount of traffic and the ratio of the processing deadline as an output.

### Traffic Amount/Processing Deadline Prediction Unit 150

The traffic amount/processing deadline prediction unit 150 predicts the traffic amount and the processing deadline after a lapse of a certain time from the current and past traffic amounts and the ratio of the processing deadline.

The traffic amount/processing deadline prediction unit 150 receives the traffic amount and the ratio of the processing deadline from the data processing deadline determination unit 140, and calculates the amount of each traffic type by multiplying the input traffic amount by the ratio of each processing deadline.

The traffic amount/processing deadline prediction unit 150 predicts whether the traffic amount of each deadline tends to increase or decrease.

### Input/Output

The traffic amount/processing deadline prediction unit 150 receives the current traffic amount of the input data and the ratio of the processing deadline as inputs, and notifies the arithmetic device allocation determination unit 130 of the predicted traffic amount and processing deadline after a lapse of a certain time as outputs.

### Modification

The traffic amount/processing deadline prediction unit 150 may predict the prediction of the traffic amount and the processing deadline in the RAN system on the basis of a transition according to a time zone at a corresponding traffic generation point or the occurrence of an event in which people gather around the traffic generation point, in addition to the method of prediction from the current traffic transition.

Specifically, a method of predicting that the traffic amount from the base station along the train is large in the time from the start to the end of the train and is small in the other time is considered. In addition, a method of predicting an increase in traffic in advance on the basis of information of an event (such as a firework display) in which people gather around the base station at a certain point may be used.

### Function Proxy Execution Unit 160

The function proxy execution unit 160 provides the same interface as the function provided by the library for accessing the existing accelerator to the application, and performs actual function execution as a proxy. As a provision form, the function proxy execution unit 160 is provided as a library for the application, and is statically linked or dynamically loaded and called at the time of execution. The same interface refers to a function having the same function name and the same argument format.

### Input/Output

### Time of Processing Request

The function proxy execution unit 160 receives a function name and an argument from the application 1 as an input, and notifies the arithmetic device distribution unit 170 of the function name and the argument as an output.

### Time of Processing Result Response

The function proxy execution unit 160 receives the processing result from the arithmetic device distribution unit 170 as an input, and notifies the application 1 of the processing result as an output.

### Arithmetic Device Distribution Unit 170

The arithmetic device distribution unit 170 distributes the input data to the arithmetic device allocated in advance.

The arithmetic device distribution unit 170 selects an accelerator satisfying the processing performance based on the processing deadline of the input data determined by the data processing deadline determination unit 140 and the determination result of the arithmetic device allocation determination unit 130, and distributes the processing to the selected accelerator.

Specifically, the arithmetic device distribution unit 170 selects an arithmetic device satisfying the processing performance on the basis of the processing deadline information included in each input data, and distributes the processing. At this time, the arithmetic device distribution unit 170 inquires the data processing deadline determination unit 140 about the processing deadline information of each data and determines the data processing deadline.

### Input/Output

### Time of Processing Request

As an input, the arithmetic device distribution unit 170 receives a list of available arithmetic devices from the arithmetic device allocation determination unit 130 and receives processing target data from the function proxy execution unit 160.

The arithmetic device distribution unit 170 transmits the processing target data to any one of the CPU 11, the accelerator 12, and the remote offload unit 180 as an output.

The arithmetic device distribution unit 170 inputs input data to the data processing deadline determination unit 140 and receives a processing deadline of the corresponding data from the data processing deadline determination unit 140.

### Processing Result Response

The arithmetic device distribution unit 170 receives the processing result from the CPU 11, the accelerator 12, and the remote offload input/output unit 14 as an input, and notifies the function proxy execution unit 160 of the processing result as an output.

### Modification

Although the arithmetic device distribution unit 170 distributes the accelerators on the basis of the processing deadline information and the traffic amount, other priority information may be used. Specifically, the priority information includes securing of an accelerator for maintenance necessary for continuous operation of the system.

In the present embodiment, the calculation result or the like of each arithmetic device (i.e., remote offload latency collection and recording unit 120, accelerator 12, remote offload input/output unit 14) is responded to the function proxy execution unit 160 via the arithmetic device distribution unit 170, but each calculation device (i.e., remote offload latency collection and recording unit 120, accelerator 12, remote offload input/output unit 14) may directly respond to the function proxy execution unit 160.

### Remote Offload Unit 180

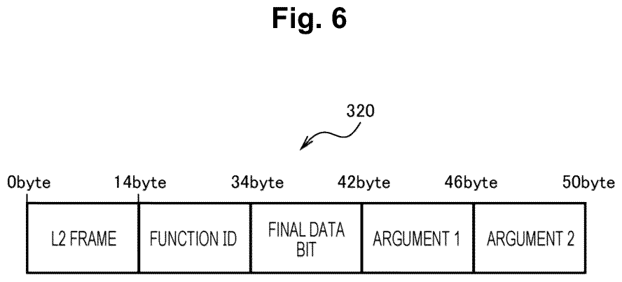

The remote offload unit 180 converts the input function name/argument into data as the L2 frame that can be transmitted by the NIC and the payload of the frame. FIG. 6 illustrates a data format of the embodiment.

### Input/Output

### Time of Offload Unit

The remote offload unit 180 receives the “function name/argument” from the arithmetic device distribution unit 170 as an input, and passes the “transmission data” to the remote offload input/output unit 14 as an output.

### Time of Response

The remote offload unit 180 receives “processing result data” from the remote offload input/output unit 14 as an input, and passes the processing result data to the arithmetic device distribution unit 170 as an output.

### Modification

The data format may not only be the L2 frame but also data to which L3 and L4 headers are added. The packet format may include not only the function name/argument but also an ID that can uniquely identify the accelerator to be utilized. In addition, in a case where the argument size is large, a function of dividing into a plurality of packets may be provided.

### Remote Offload Server 210

The remote offload server 210 includes hardware (HW) 10 and software 20.

### Hardware 10

The hardware 10 includes a CPU 11, an accelerator (remote) (high performance) 12-3, and a remote offload input/output unit (server) (NIC) 14.

### CPU11

The CPU 11 executes processing of the application 1 and executes software of each functional unit in the remote offload server 210.

### Accelerator 12

The accelerator (remote) (high performance) 12-3 is a calculation accelerator device such as an FPGA/GPU. The accelerator (remote) (high performance) 12-3 is an arithmetic unit mounted on the remote offload server 210 and specialized for specific processing. As a form of being connected to the CPU 11 via a bus, there are forms such as an ASIC mounted accelerator, an FPGA mounted accelerator, and a GPU.

In the present embodiment, “performance hetero configuration” in which a plurality of accelerators having different processing capacities can be used is used. The plurality of accelerators having different processing capacities include the accelerator (high performance) 12-1, the accelerator (low performance) 12-2 mounted on the server 200, and the accelerator (remote) (high performance) 12-3 mounted on the remote offload server 210.

### Software 20

The software 20 includes a remote offload reception unit 211.

The remote offload reception unit 211 offloads the processing target data received via the network to the accelerator (remote) 12-3 and responses with the result.

### Input/Output

### Time of Offload Unit

The remote offload reception unit 211 receives data in the format of FIG. 6 as an input and performs processing offloading on the accelerator (remote) 12-3 as an output.

### Time of Response

The remote offload reception unit 211 receives the offload result from the accelerator (remote) 12-3 as an input and responds to the processing result as data in the format of FIG. 6 as an output.

### Antenna Device 220

The antenna device 220 is an antenna and a transmission/reception unit that wirelessly communicate with the terminal (user equipment (UE)) (hereinafter, the “antenna device” collectively refers to an antenna, a transmission/reception unit, and a power supply unit thereof.). The transmission/reception data is connected to a signal processing device (server 200) of a base band unit (BBU) by, for example, a dedicated cable.

The antenna device 220 includes an antenna device data input/output unit 221. The antenna device data input/output unit 221 is a functional unit that transmits a signal generated by the antenna device 220 to the server 200, and is implemented in a form of an NIC or the like.

### Subsequent-stage Processing Device 230

The subsequent-stage processing device 230 is a centralized unit in 5G signal processing.

The subsequent-stage processing device 230 includes a subsequent-stage processing device data input/output unit 231. The subsequent-stage processing device data input/output unit 231 is a functional unit that receives a signal processing result processed by the server 200, and is implemented in a form of an NIC or the like.

### Other Embodiments

In the present embodiment, the input/output unit 13, the CPU 11, and the accelerator 12 are configured separately as hardware, but may be in the form of dedicated hardware in which the CPU 11, the accelerator 12, and the accelerator operation circuit program 12a are integrated.

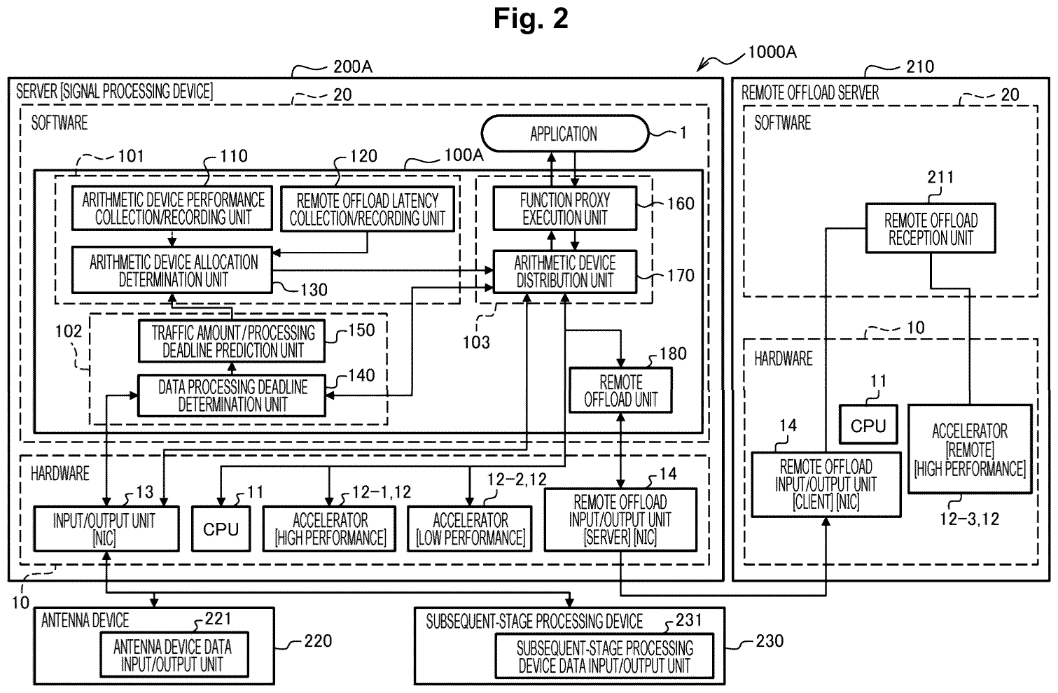

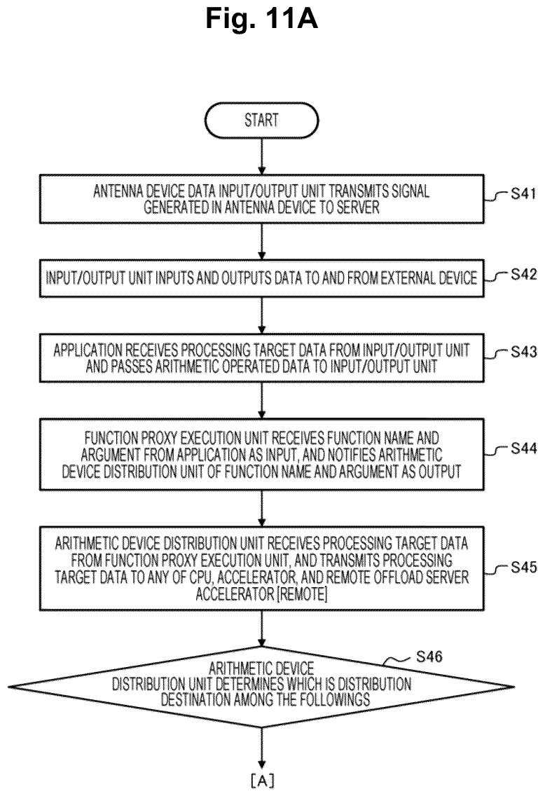

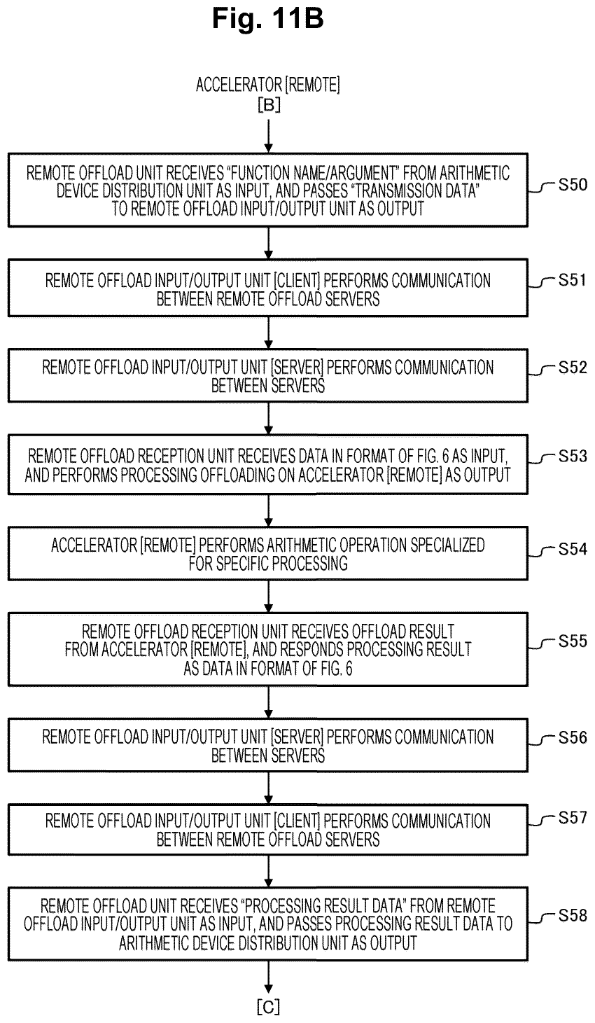

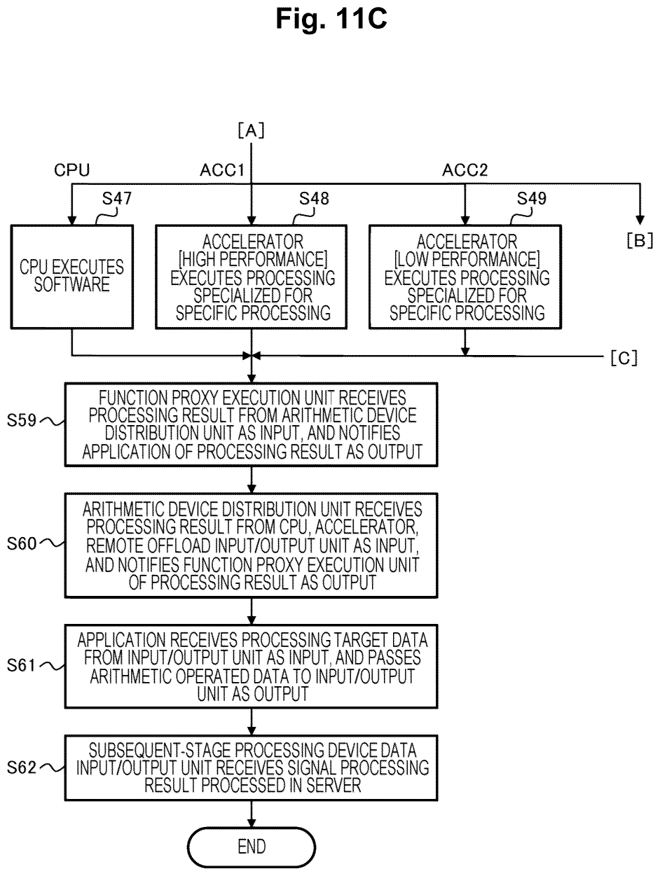

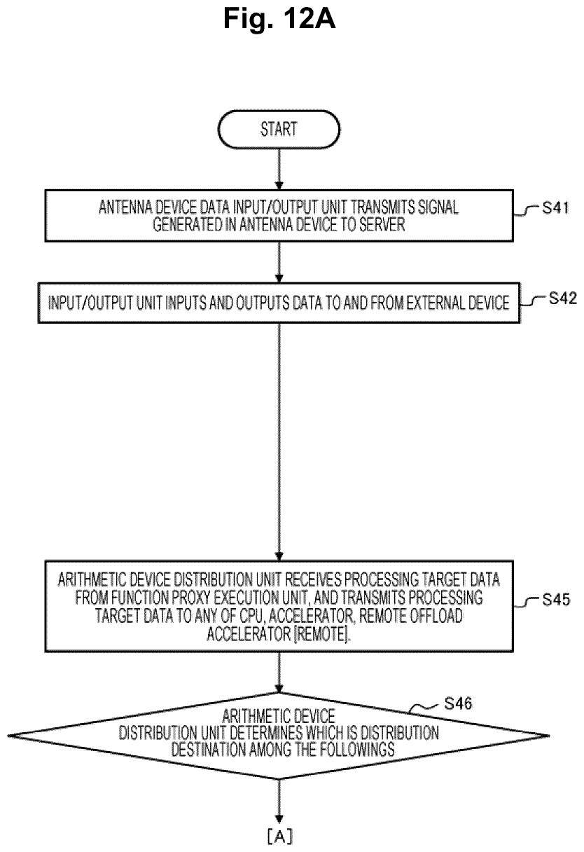

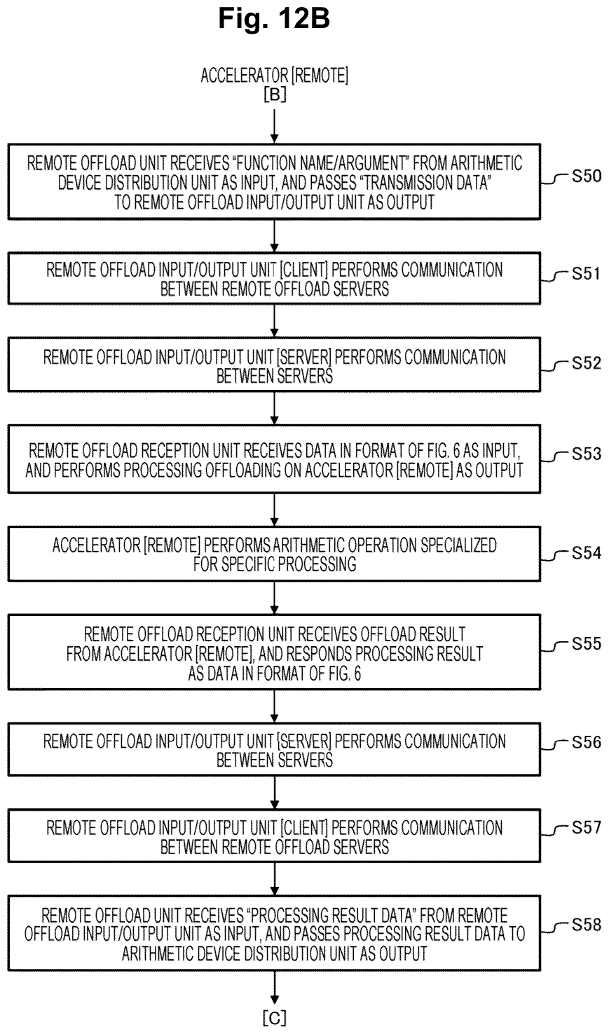

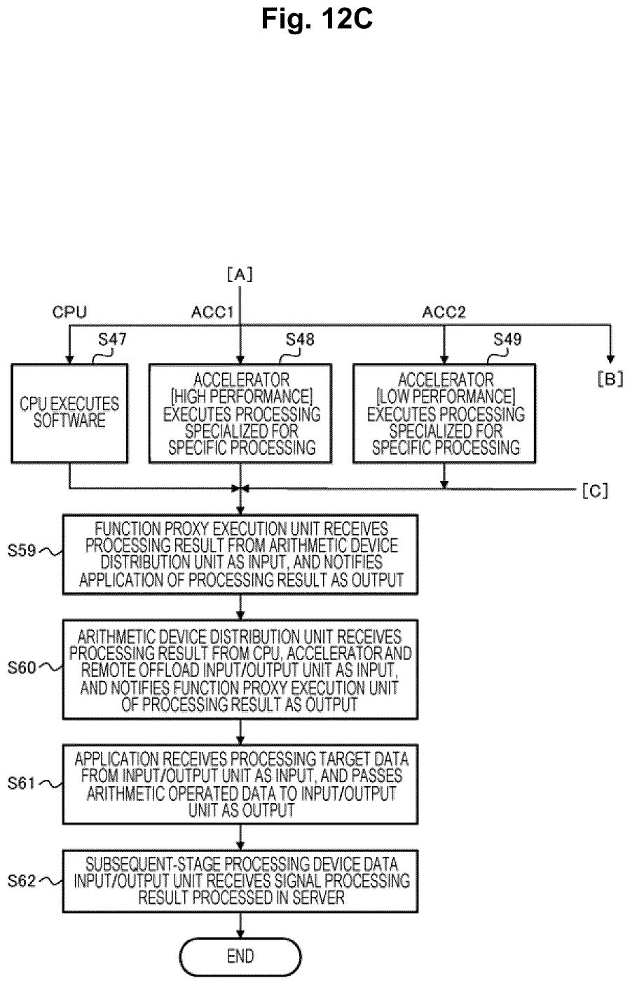

In other words, as illustrated in FIG. 1, in addition to a so-called Look-Aside type accelerator application form (i.e., the sequence of FIGS. 11A to 11C) “explicitly offload data obtained via the input/output unit 13 such as an NIC from the CPU 11 to the accelerator 12”, a so-called In-line type accelerator application form (i.e., the sequence of FIGS. 12A to 12C) in which processing is completed in the same hardware after data is received by the NIC by hardware in which the “NIC accelerator CPU” is integrated as described later with reference to FIG. 2 may be used.

In addition, the CPU 11 and the accelerator 12 may be mounted in a single chip such as a system on chip (SoC).

### Accelerator Application Form of Accelerator State Control Device

FIG. 2 is a schematic configuration diagram of a power saving accelerator state management system 1000A according to an embodiment of the present invention. FIG. 2 illustrates an in-line type accelerator application form. The same components as those in FIG. 1 are denoted by the same reference signs as those used in FIG. 1, and redundant description is not made.

In the accelerator state control device 100A of the server 200A of the in-line accelerator application form illustrated in FIG. 2, there is no bidirectional signal line connecting the input/output unit 13 and the accelerator 12 in the accelerator state control device 100 of the server 200 of FIG. 1. In addition, in the accelerator state control device 100A of the server 200 of the in-line type accelerator application form illustrated in FIG. 2, a bidirectional signal line connecting the input/output unit 13 and the arithmetic device distribution unit 170 is newly added.

The server 200A of the in-line type accelerator application form copies data directly from the NIC to the accelerator. The accelerator autonomously performs operation like a dedicated circuit.

### Arrangement of Accelerator State Control Device

A variation in arrangement of an accelerator state control device of the accelerator state control system will be described.

The accelerator state control system 1000 of FIG. 1 is an example in which the accelerator state control device 100 is arranged in the software 20 of the server 200. A part of the functions of the accelerator state control device 100 can be installed as a separate housing outside the server 200, and will be exemplified below.

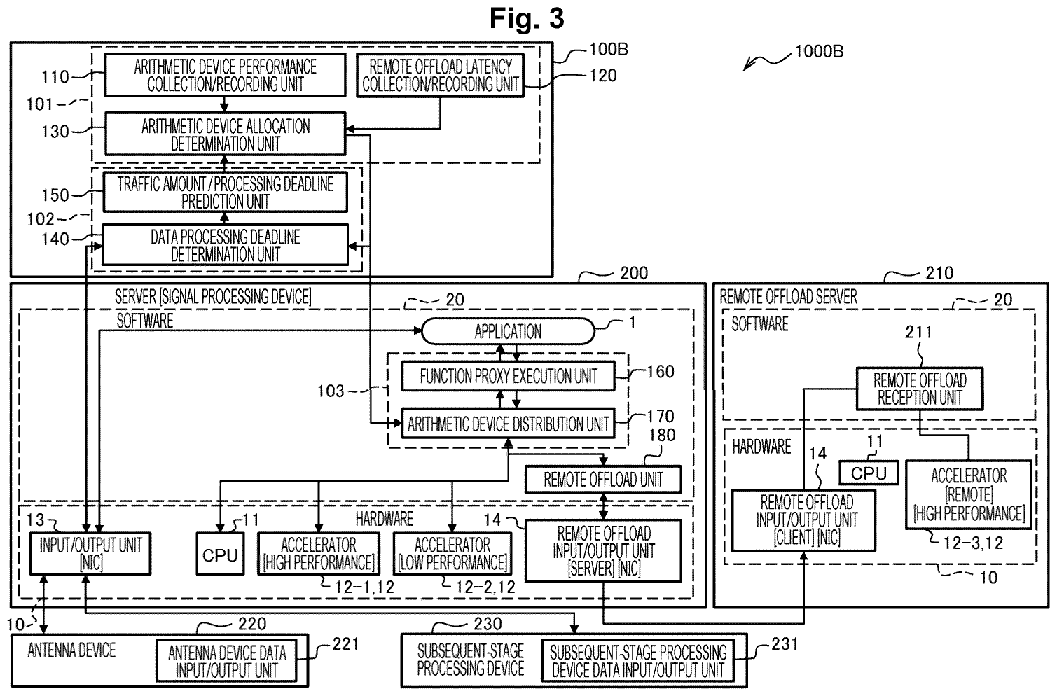

FIG. 3 is a schematic configuration diagram illustrating a variation in arrangement of an accelerator state control device of the accelerator state control system. In each drawing described below, the same components as those in FIG. 1 are denoted by the same reference signs, and the description of overlapping portions is omitted.

The variation illustrated in FIG. 3 is an example of a case where the controller function unit including the arithmetic device performance collection/recording unit 110, the remote offload latency collection/recording unit 120, the arithmetic device allocation determination unit 130, the data processing deadline determination unit 140, and the traffic amount/processing deadline prediction unit 150 is a separate housing.

As illustrated in FIG. 3, the accelerator state control system 1000B includes an accelerator state control device 100B installed as a separate housing outside the server 200.

The software 20 of the server 200 includes an application 1, a function proxy execution unit 160, and an arithmetic device distribution unit 170.

In the accelerator state control device 100B, the controller function unit is installed outside the server 200, and has the same function as the accelerator state control device 100, 100A in FIGS. 1 and 2.

As described above, as illustrated in FIG. 3, by adopting a form in which some or all of the respective functions of the accelerator state control device are independently deployed in another housing outside the server 200, it is possible to cope with function deployment to a RAN intelligent controller (RIC) in a radio access network (RAN).

In addition, since the input amount can be predicted on the basis of the input amount acquisition (function 1) from a plurality of server machines by arranging the controller function unit outside, there is an advantage that prediction accuracy of traffic of the function 1 is improved. For example, in a wireless system of a mobile phone, when a traffic amount of a processing area of which a certain server machine is in charge increases, it is assumed that an input amount of a nearby processing area also fluctuates behind the increase.

In addition, the plurality of servers 200 can be operated by one accelerator state control device. Accordingly, cost reduction and maintainability of the accelerator state control device can be improved. In addition, it is possible to eliminate or reduce modifications on the server side, and it is possible to apply the present technology in a general-purpose manner.

### DB Table of Arithmetic Device Performance Collection/Recording Unit 110

FIG. 4 is a diagram illustrating an example of the DB table 300 of the arithmetic device performance collection/recording unit 110.

As illustrated in FIG. 4, the DB table 300 holds an accelerator identifier (i.e., CPU, FPGA, ASIC), ACC performance (throughput), ACC performance (processing latency), and ACC performance (power consumption) for each mounted host information. For example, the mounted host information “Host-1 (192.168. 0.1: server URL)” is the accelerator identifier “FPGA-1”, the ACC performance (throughput) “10.0 Gbps”, the ACC performance (processing latency) “5.0 μs”, and the ACC performance (power consumption) “120.0 W”. Each ACC performance is recorded in association with the mounted host information, and each ACC performance of the host can be known by designating the mounted host information.

### Latency Table of Remote Offload Latency Collection/Recording Unit 120

FIG. 5 is a diagram illustrating an example of the latency table 310 of the remote offload latency collection/recording unit 120.

As illustrated in FIG. 5, the latency table 310 retains (or records) access source host information, access destination host information, and latency. For example, in a case where the access source host information “Host-1 (192.168.0.1: server URL)” is connected to the access destination host information “Host-2 (192.168.0.2)”, the latency (i.e., connection latency/communication latency) is “30 μs”.

### Data Structure of Remote Offload Unit 180

FIG. 6 is a diagram illustrating a configuration example of an ACC function/argument data packet 320 of the remote offload unit 180.

As illustrated in FIG. 6, the ACC function/argument data packet 320 is formatted with an L2 frame (0 to 14 bytes), a function ID (up to 34 bytes), a final data bit (up to 42 bytes), an argument 1 (up to 46 bytes), and an argument 2 (up to 50 bytes).

The ACC function/argument data packet 320 has a data structure suitable for parsing in the circuit of the FPGA by setting each piece of data to a fixed length and a fixed position.

The control bits add control information to the packet. For example, in a case where the argument size is large, the ACC function/argument data packet 320 has a function of dividing argument data into a plurality of packets. At this time, control data for notifying the “control bit” of the last packet is added to the last divided packet.

In the packet format illustrated in FIG. 6, an L3 header and an L4 header may be included in the header. Furthermore, the packet format may include not only the function name/argument but also an ID that can uniquely identify the accelerator to be utilized.

### Calculation Example of Available ACC List from Host-1

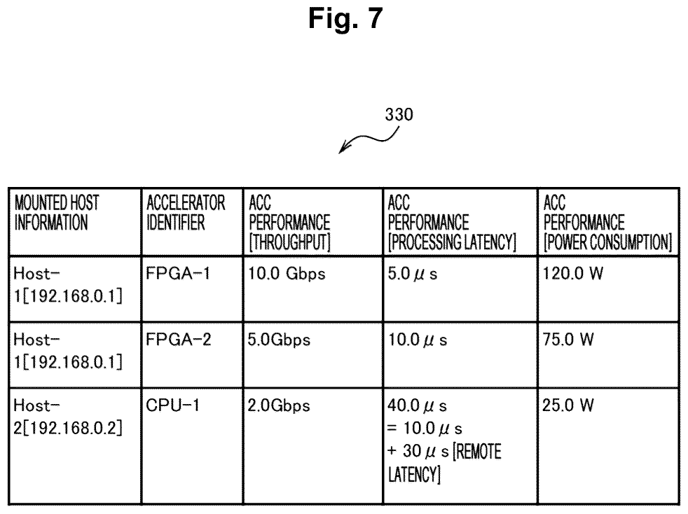

FIG. 7 is a diagram illustrating a calculation example of the available ACC list 330 from the Host-1.

As illustrated in FIG. 7, the available ACC list 330 is created on the basis of the DB table 300 of the arithmetic device performance collection/recording unit 110 illustrated in FIG. 4 and the latency table 310 of the remote offload latency collection/recording unit 120 illustrated in FIG. 5. The available ACC list 330 can list ACC performance (throughput), ACC performance (processing latency), and ACC performance (power consumption) when another host is used from the host. For example, in a case where the Host-2 is used from the Host-1, the ACC performance (processing latency) is “40.0 μs=10.0 μs+30 us (remote latency)”, which is an important index when the Host-1 uses the Host-2.

The arithmetic device allocation determination unit 130 selects a combination of accelerators having the lowest power consumption while satisfying the performance from the list of the DB table 300 of the arithmetic device performance collection/recording unit 110 illustrated in FIG. 4, and notifies the arithmetic device distribution unit 170 of the combination. However, the remoting latency is also taken into account, especially if the accelerator is remote via the network. Using the available ACC list 330, the arithmetic device allocation determination unit 130 determines an arithmetic device that satisfies performance in consideration of the remoting latency, and allocates the arithmetic device to the arithmetic device distribution unit 170.

Hereinafter, an operation of the accelerator state control system 1000 configured as described above will be described.

First, operations of the arithmetic device allocation determination unit 130 and the traffic amount/processing deadline prediction unit 150 will be described.

### Operation 1 of Arithmetic Device Allocation Determination Unit 130 and Traffic Amount/Processing Deadline Prediction Unit 150

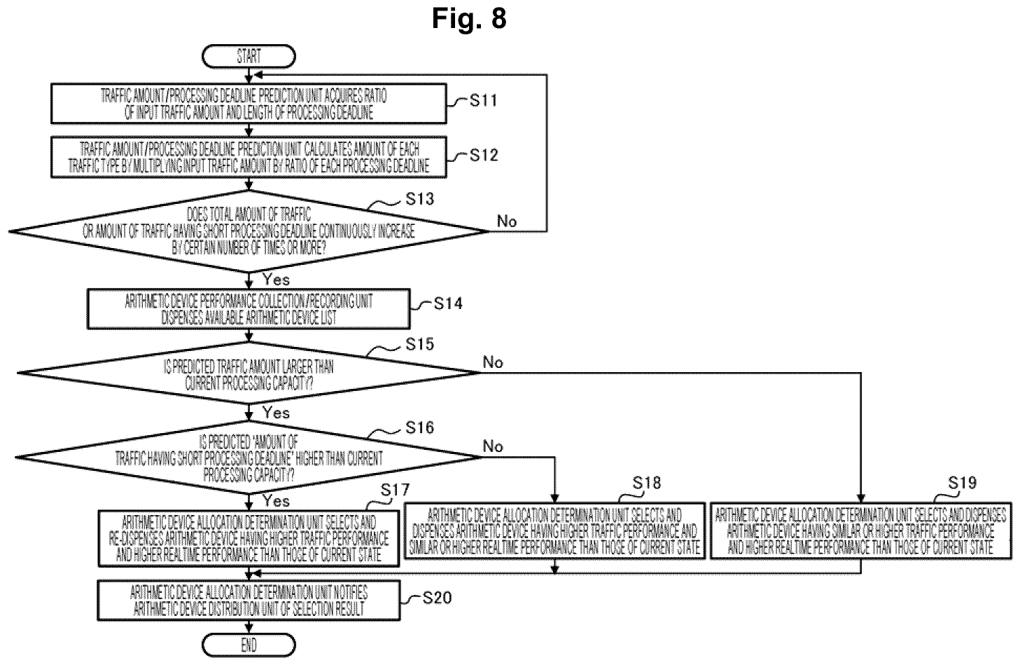

FIG. 8 is a flowchart illustrating operation 1 of the arithmetic device allocation determination unit 130 and the traffic amount/processing deadline prediction unit 150. FIG. 8 illustrates a case where a traffic amount or a ratio of traffic having a high processing deadline increases.

In step S11, the traffic amount/processing deadline prediction unit 150 acquires the ratio of the length of the input traffic amount/processing deadline.

In step S12, the traffic amount/processing deadline prediction unit 150 multiplies the input traffic amount by the ratio of each processing deadline to calculate the amount of each traffic type.

In step S13, the traffic amount/processing deadline prediction unit 150 determines whether the total amount of traffic or the amount of traffic having a short processing deadline continuously increases a certain number of times or more.

When the total amount of traffic or the amount of traffic having a short processing deadline has not continuously increased for a certain number of times or more (S12: No), the process returns to step S11.

When the total amount of traffic or the amount of traffic having a short processing deadline continuously increases a certain number of times or more (S12: Yes), the arithmetic device performance collection/recording unit 110 dispenses an available arithmetic device list (DB table 300 in FIG. 4) in step S14 (hereinafter, “dispensing” refers to taking out information and responding).

In step S15, the arithmetic device allocation determination unit 130 determines whether the predicted traffic amount is larger than the current processing capacity.

When the predicted traffic amount is larger than the current processing capacity (S15: Yes), in step S16, the arithmetic device allocation determination unit 130 determines whether the predicted “amount of traffic having a short processing deadline” is higher than the current processing capacity.

When the predicted “amount of traffic having a short processing deadline” is higher than the current processing capacity (S16: Yes), in step S17, the arithmetic device allocation determination unit 130 selects and re-dispenses the arithmetic device having higher traffic performance and higher real-time performance than the current state, and proceeds to step S20.

When the predicted “amount of traffic having a short processing deadline” is not higher than the current processing capacity (S16: No), in step S18, the arithmetic device allocation determination unit 130 selects and re-dispenses the arithmetic device having higher traffic performance and similar or higher real-time performance than the current state, and proceeds to step S20.

On the other hand, when the traffic amount predicted in step S15 is equal to or less than the current processing capacity (S15: No), it is determined that the traffic amount does not increase and “the ratio of traffic having high processing deadlines” is high, and the arithmetic device allocation determination unit 130 selects and re-dispenses the arithmetic device having the similar or higher traffic performance and the higher real-time performance than the current state in step S19, and proceeds to step S20.

In step S20, the arithmetic device allocation determination unit 130 notifies the arithmetic device distribution unit 170 of the selection result and ends the processing of this flow.

### Operation 2 of Arithmetic Device Allocation Determination Unit 130 and Traffic Amount/Processing Deadline Prediction Unit 150

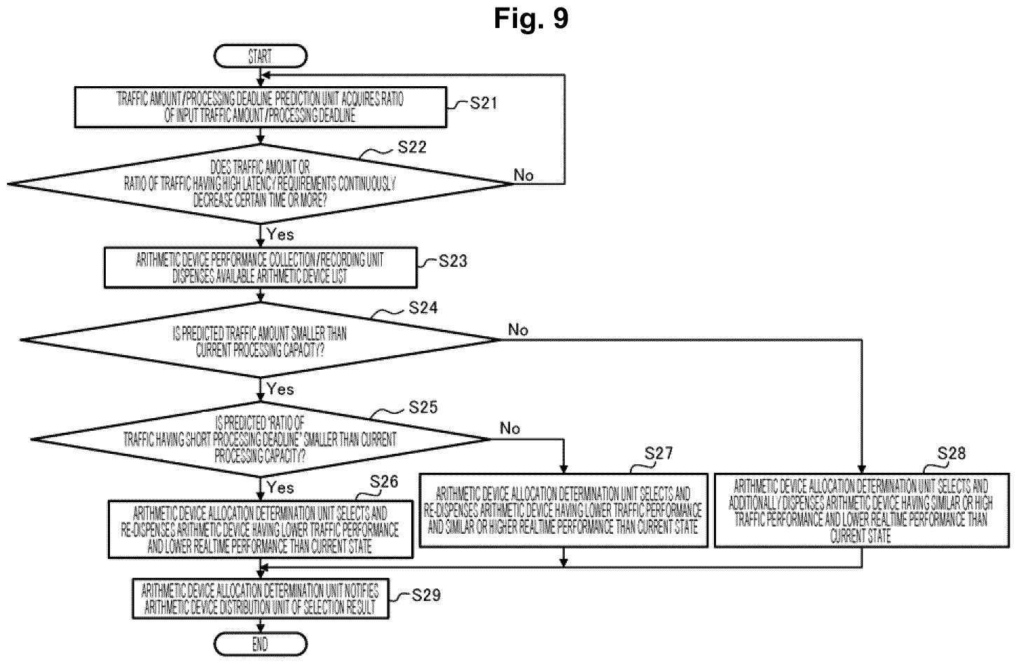

FIG. 9 is a flowchart illustrating operation 2 of the arithmetic device allocation determination unit 130 and the traffic amount/processing deadline prediction unit 150. FIG. 9 illustrates a case where a traffic amount or a ratio of traffic having a high processing deadline decreases.

In step S21, the traffic amount/processing deadline prediction unit 150 acquires the ratio of the input traffic amount/processing deadline.

In step S22, the traffic amount/processing deadline prediction unit 150 determines whether the total amount of traffic or the ratio of traffic having high latency requirements continuously decreases a certain number of times or more.

When the total amount of traffic or the ratio of traffic having high latency requirements has not continuously increased for a certain number of times or more (S22: No), the process returns to step S21.

When the total amount of traffic or the ratio of traffic having high latency requirements continuously decreases a certain number of times or more (S22: Yes), the arithmetic device performance collection/recording unit 110 dispenses an available arithmetic device list (DB table 300 in FIG. 4) in step S23.

In step S24, the arithmetic device allocation determination unit 130 determines whether the predicted traffic amount is smaller than the current processing capacity.

When the predicted traffic amount is smaller than the current processing capacity (S24: Yes), in step S25, the arithmetic device allocation determination unit 130 determines whether the predicted “amount of traffic having a short processing deadline” is lower than the current processing capacity.

When the predicted “ratio of traffic having a short processing deadline” is lower than the current processing capacity (S25: Yes), in step S26, the arithmetic device allocation determination unit 130 selects and re-dispenses the arithmetic device having higher traffic performance and lower real-time performance than the current state, and proceeds to step S29.

When the predicted “ratio of traffic having a short processing deadline” is not lower than the current processing capacity (S25: No), in step S27, the arithmetic device allocation determination unit 130 selects and re-dispenses the arithmetic device having lower traffic performance and similar or higher real-time performance than the current state, and proceeds to step S29.

On the other hand, when the traffic amount predicted in step S24 is equal to or higher than the current processing capacity (S24: No), it is determined that the traffic amount does not decrease and “the ratio of traffic having high latency requirements” decreases, and the arithmetic device allocation determination unit 130 selects and re-dispenses the arithmetic device having the similar or higher traffic performance and the lower real-time performance than the current state in step S28, and proceeds to step S29.

In step S29, the arithmetic device allocation determination unit 130 notifies the arithmetic device distribution unit 170 of the selection result and ends the processing of this flow.

### Arithmetic Device Allocation (ACC Allocation)

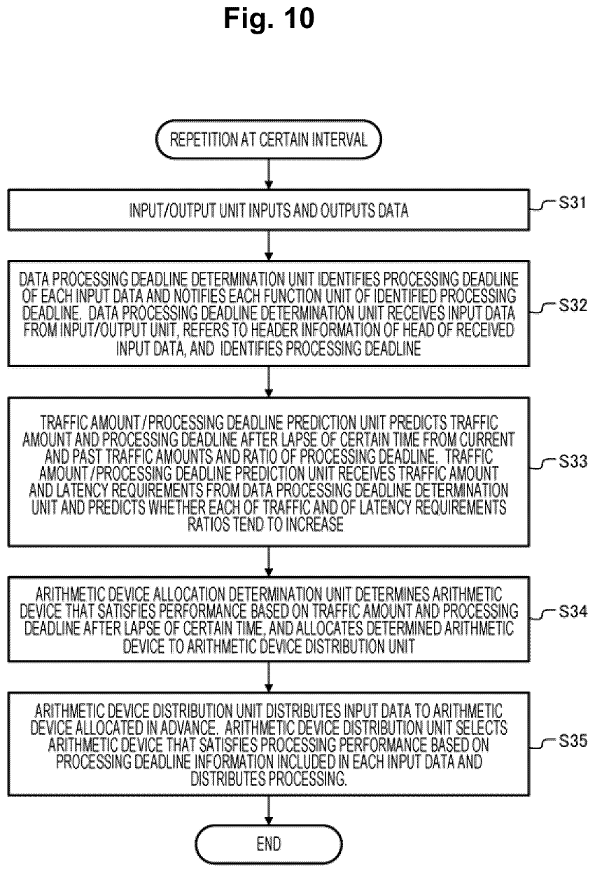

FIG. 10 is a flowchart illustrating arithmetic device allocation (ACC allocation).

In step S31, the input/output unit 13 inputs and outputs data.

In step S32, the data processing deadline determination unit 140 identifies the processing deadline of each input data and then notifies each functional unit of the processing deadline. The data processing deadline determination unit 140 receives input data from the input/output unit, refers to header information at the head of the input data, and identifies a processing deadline.

In step S33, the traffic amount/processing deadline prediction unit 150 predicts the traffic amount and the processing deadline after a lapse of a certain time from the current and past traffic amounts and the ratio of the processing deadline. The traffic amount/processing deadline prediction unit 150 receives the traffic amount and the latency requirements from the data processing deadline determination unit 140, and predicts whether the ratios of the traffic and the latency requirements tend to increase.

In step S34, the arithmetic device allocation determination unit 130 determines an arithmetic device that satisfies performance on the basis of the traffic amount and the processing deadline after a lapse of a certain time, and allocates the arithmetic device to the arithmetic device distribution unit 170.

In step S35, the arithmetic device distribution unit 170 distributes the input data to the arithmetic device allocated in advance. The arithmetic device distribution unit 170 selects an arithmetic device satisfying the processing performance on the basis of the processing deadline information included in each input data, and distributes the processing, and ends the processing of this flow.

### Input Data Processing

FIGS. 11A to 11C are flowcharts illustrating input data processing. FIGS. 11A to 11C correspond to a Look-Aside type accelerator application form.

FIGS. 11A to 11C illustrate one flow, but for convenience of illustration, [A], [B], and [C] are connected as connectors.

In FIG. 11A, in step S41, the antenna device data input/output unit 221 of the antenna device 220 transmits a signal generated by the antenna device 220 to the server 200.

In step S42, the input/output unit 13 inputs/outputs data to/from an external device (the antenna device 220).

In step S43, the application 1 receives the processing target data from the input/output unit 13 and passes the arithmetic operated data to the input/output unit 13.

In step S44, the function proxy execution unit 160 receives a function name and an argument from the application as an input, and notifies the arithmetic device distribution unit 170 of the function name and the argument as an output.

In step S45, the arithmetic device distribution unit 170 receives the processing target data from the function proxy execution unit 160, and sends the processing target data to any one of the CPU 11, the accelerator 12, and the accelerator [remote] 12-3 of the remote offload server.

In step S46, the arithmetic device distribution unit 170 determines which is the distribution destination among the followings.

In a case where the distribution destination is the CPU, the CPU 11 executes the software in step S47 of FIG. 11C and proceeds to step S59.

In a case where the distribution destination is the accelerator 1 (accelerator 12-1), the accelerator [high performance] 12-1 executes processing specialized for specific processing in step S48 of FIG. 11C and proceeds to step S59.

In a case where the distribution destination is the accelerator 2 (accelerator 12-2), the accelerator [low performance] 12-2 executes processing specialized for specific processing in step S49 of FIG. 11C and proceeds to step S59.

In a case where the distribution destination is the accelerator [remote] (accelerator 12-3), the process proceeds to step S50 of FIG. 11B.

In FIG. 11B, in step S50, the remote offload unit 180 receives the “function name/argument” from the arithmetic device distribution unit 170 as an input, and passes the “transmission data” to the remote offload input/output unit 14 as an output.

In step S51, the remote offload input/output unit [client] 14 performs communication between the remote offload servers.

In step S52, the remote offload input/output unit [server] 14 performs communication between the servers.

In step S53, the remote offload reception unit 211 receives data in the format of FIG. 6 as an input and performs processing offloading on the accelerator [remote] 12-3 as an output.

In step S54, the accelerator [remote] 12-3 performs arithmetic operation specialized for specific processing.

In step S55, the remote offload reception unit 211 receives the offload result from the accelerator [remote] and responds to the processing result as data in the format of FIG. 6.

In step S56, the remote offload input/output unit [server] 14 performs communication between the servers.

In step S57, the remote offload input/output unit [client] 14 performs communication between the remote offload servers.

In step S58, the remote offload unit 180 receives “processing result data” from the remote offload input/output unit 14 as an input, and passes the processing result data to the arithmetic device distribution unit 170 as an output, and proceeds to step S59 of FIG. 11C.

In step S59 of FIG. 11C, the function proxy execution unit 160 receives the processing result from the arithmetic device distribution unit 170 as an input, and notifies the application of the processing result as an output.

In step S60, the arithmetic device distribution unit 170 receives the processing result from the CPU, the accelerator 12, and the remote offload input/output unit 14 as inputs, and notifies the function proxy execution unit 160 of the processing result as an output.

In step S61, the application 1 receives the processing target data from the input/output unit 13 and passes the arithmetic operated data as an output to the input/output unit 13.

In step S62, the subsequent-stage processing device data input/output unit 231 of the subsequent-stage processing device 230 receives the signal processing result processed by the server, and ends the processing of this flow.

FIGS. 12A to 12C are flowcharts illustrating input data processing. FIGS. 12A to 12C correspond to an In-line type accelerator application form. The same types of processing as those in FIGS. 11A to 11C are denoted by the same step numbers.

FIGS. 12A to 12C illustrate one flow, but for convenience of illustration, [A], [B], and [C] are connected as connectors.

In FIG. 12A, in step S41, the antenna device data input/output unit 221 of the antenna device 220 transmits a signal generated by the antenna device 220 to the server 200.

In step S42, the input/output unit 13 inputs/outputs data to/from an external device (the antenna device 220).

In step S45, the arithmetic device distribution unit 170 receives the processing target data from the function proxy execution unit 160, and sends the processing target data to any one of the CPU 11, the accelerator 12, and the accelerator [remote] 12-3 of the remote offload server.

In step S46, the arithmetic device distribution unit 170 determines which is the distribution destination among the followings.

In a case where the distribution destination is the CPU, the CPU 11 executes the software in step S47 of FIG. 12C and proceeds to step S59.

In a case where the distribution destination is the accelerator 1 (accelerator 12-1), the accelerator [high performance] 12-1 executes processing specialized for specific processing in step S48 of FIG. 12C and proceeds to step S59.

In a case where the distribution destination is the accelerator 2 (accelerator 12-2), the accelerator [low performance] 12-2 executes processing specialized for specific processing in step S49 of FIG. 12C and proceeds to step S59.

In a case where the distribution destination is the accelerator [remote] (accelerator 12-3), the process proceeds to step S50 of FIG. 12B.

In FIG. 12B, in step S50, the remote offload unit 180 receives the “function name/argument” from the arithmetic device distribution unit 170 as an input, and passes the “transmission data” to the remote offload input/output unit 14 as an output.

In step S51, the remote offload input/output unit [client] 14 performs communication between the remote offload servers.

In step S52, the remote offload input/output unit [server] 14 performs communication between the servers.

In step S53, the remote offload reception unit 211 receives data in the format of FIG. 6 as an input and performs processing offloading on the accelerator [remote] 12-3 as an output.

In step S54, the accelerator [remote] 12-3 performs arithmetic operation specialized for specific processing.

In step S55, the remote offload reception unit 211 receives the offload result from the accelerator [remote] and responds to the processing result as data in the format of FIG. 6.

In step S56, the remote offload input/output unit [server] 14 performs communication between the servers.

In step S57, the remote offload input/output unit [client] 14 performs communication between the remote offload servers.

In step S58, the remote offload unit 180 receives “processing result data” from the remote offload input/output unit 14 as an input, and passes the processing result data to the arithmetic device distribution unit 170 as an output, and proceeds to step S59 of FIG. 12C.

In step S59 of FIG. 12C, the function proxy execution unit 160 receives the processing result from the arithmetic device distribution unit 170 as an input, and notifies the application of the processing result as an output.

In step S60, the arithmetic device distribution unit 170 receives the processing result from the CPU, the accelerator 12, and the remote offload input/output unit 14 as inputs, and notifies the function proxy execution unit 160 of the processing result as an output.

In step S61, the application 1 receives the processing target data from the input/output unit 13 and passes the arithmetic operated data as an output to the input/output unit 13.

In step S62, the subsequent-stage processing device data input/output unit 231 of the subsequent-stage processing device 230 receives the signal processing result processed by the server, and ends the processing of this flow.

### Hardware Configuration

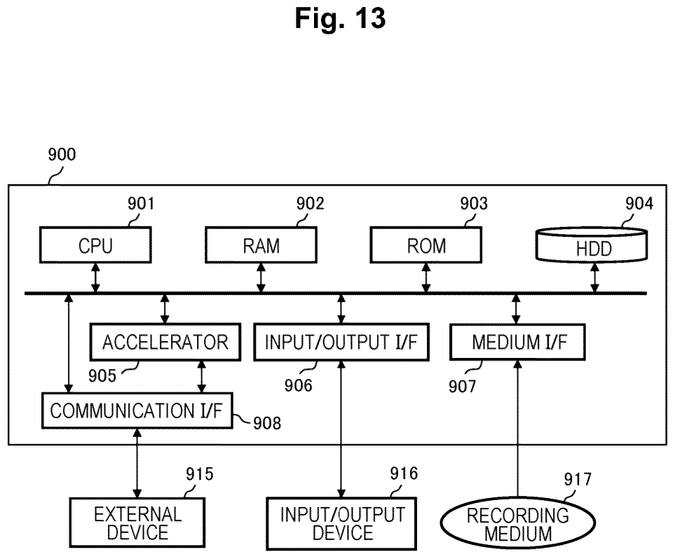

The accelerator state control device 100 (FIG. 1) of the accelerator state control systems 1000, 1000A (FIGS. 1 and 2) according to the embodiment described above is implemented by a computer 900 having a configuration as illustrated in FIG. 13, for example.

FIG. 13 is a hardware configuration diagram illustrating an example of the computer 900 that implements the functions of the accelerator state control device 100.

The accelerator state control device 100 includes a CPU 901, RAM 902, ROM 903, an HDD 904, an accelerator 905, an input/output interface (I/F) 906, a media interface (I/F) 907, and a communication interface (I/F) 908. The accelerator 905 corresponds to the accelerator 12 in FIGS. 1 and 2.

The accelerator 905 is an accelerator (device) 12 (FIGS. 1 and 2) that processes at least one of data from the communication I/F 908 or data from the RAM 902 at high speed. Note that the accelerator 905 may be of a type (Look-Aside type) that executes processing from the CPU 901 or the RAM 902 and then returns the execution result to the CPU 901 or the RAM 902. On the other hand, the accelerator 905 may also be of a type (In-line type) that is interposed between the communication I/F 908 and the CPU 901 or the RAM 902 and performs processing.

The accelerator 905 is connected to an external device 915 via the communication I/F 908. The input/output I/F 906 is connected to an input/output device 916. The media I/F 907 reads and writes data from and to a recording medium 917.

The CPU 901 operates on the basis of a program stored in the ROM 903 or the HDD 904 and controls each component of the accelerator state control devices 100, 100A in FIGS. 1 and 2 by executing the program (also referred to as an application or App as an abbreviation thereof) read in the RAM 902. Then, the program may be distributed via a communication line or distributed by being recorded in the recording medium 917 such as a CD-ROM.

The ROM 903 stores a boot program to be executed by the CPU 901 at the time of activating the computer 900, a program depending on the hardware of the computer 900, and the like.

The CPU 901 controls the input/output device 916 including an input unit such as a mouse or a keyboard and an output unit such as a display or a printer via the input/output I/F 906. The CPU 901 acquires data from the input/output device 916 and outputs generated data to the input/output device 916 via the input/output I/F 906. Note that a graphics processing unit (GPU) or the like may be used as a processor in conjunction with the CPU 901.

The HDD 904 stores a program to be executed by the CPU 901, data to be used by the program, and the like. The communication I/F 908 receives data from another device via a communication network (for example, the network (NW)), outputs the data to the CPU 901, and transmits data generated by the CPU 901 to another device via the communication network.

The media I/F 907 reads a program or data stored in the recording medium 917, and outputs the program or data to the CPU 901 via the RAM 902. The CPU 901 loads a program regarding target processing from the recording medium 917 onto the RAM 902 via the media I/F 907 and executes the loaded program. The recording medium 917 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, in a case where the computer 900 functions as the accelerator state control device 100 (FIG. 1) configured as one device according to the present embodiment, the CPU 901 of the computer 900 implements the functions of the accelerator state control device 100 by executing the program loaded onto the RAM 902. The HDD 904 stores data in the RAM 902. The CPU 901 reads the program regarding the target processing from the recording medium 917 and executes the program. Additionally, the CPU 901 may read the program regarding the target processing from another device via the communication network.

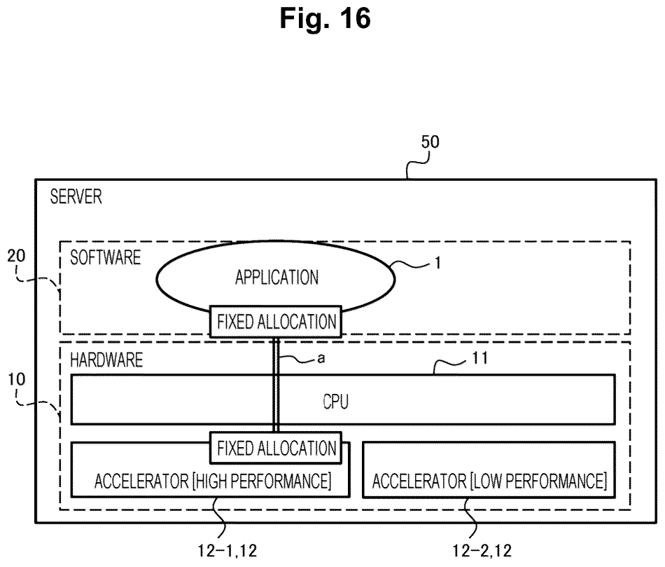

When the controller function unit illustrated in FIG. 3 is installed outside the server 200, the accelerator state control device 100A is similarly realized by the computer 900 having the configuration illustrated in FIG. 16.

### Effects

As described above, accelerator state control devices 100, 100A, and 100B (FIGS. 1 to 3) respectively include a plurality of accelerators 12 having different processing performance, and control a state of the accelerators when arithmetic processing is performed by offloading specific processing of an application 1 to the accelerator 12. Herein, the accelerator state control device includes: when data in which different processing deadlines are mixed is input, a recording unit (arithmetic device performance collection/recording unit 110) that collects and records performance information of the accelerator 1; a prediction unit (traffic amount/processing deadline prediction unit 150) that predicts a traffic amount and a processing deadline after a lapse of a predetermined time from a ratio between current and past traffic amounts and a processing deadline. The accelerator state control device further includes: a determination unit (arithmetic device allocation determination unit 130) that obtains a data amount corresponding to the processing deadline on the basis of the traffic amount and the processing deadline after the lapse of the predetermined time predicted by the prediction unit and the performance of the accelerator recorded in the recording unit, and determines an accelerator that satisfies the performance on the basis of the data amount.

As described in the problem to be solved, in Existing Technology 1 (i.e., static allocation), the resource amount of the accelerator is constant and <Requirement 2: Scalability> is not satisfied. Existing Technology 2 (i.e., scale-out by function proxy) does not consider a difference in performance of the respective accelerators, and thus <Requirement 1: Satisfaction of Processing Deadline of Each Data> is not satisfied. For this reason, Existing Technology 1 has poor versatility because the scale is fixed, and Existing Technology 2 is not suitable for processing requiring low latency because the ratio at which responsiveness can be secured is fixed. On the other hand, in the accelerator state control device 100 according to the present embodiment, accelerators are allocated and offloaded on the basis of the processing deadline of each data by using accelerators of a hetero configuration of performance that can use a plurality of different accelerators. As a result, the accelerator state control device 100 can realize both versatility and low latency which cannot be realized by Existing Technologies 1 and 2.

Therefore, the accelerator state control devices 100, 100A, and 100B (FIGS. 1 to 3) can achieve dynamic dispensing of the accelerator and satisfy [Requirement 2: Scalability]. In addition, the accelerator state control devices 100, 100A, and 100B can satisfy [Requirement 1: Satisfaction of Responsiveness of Each Data] by selecting an accelerator that satisfies performance and minimizes power consumption from the allocated accelerators on the basis of the processing deadline for each data at the time of arithmetic operation, and offloading the selected accelerator. As a result, the accelerator state control device 100 can reduce operation resources to be used while ensuring responsiveness according to a variation in the data amount corresponding to each processing deadline.

The accelerator state control devices 100, 100A, and 100B (FIGS. 1 to 3) respectively include: a data processing deadline determination unit 140 that identifies and provides notification of a processing deadline of input data; and a distribution unit (arithmetic device distribution unit 170) that selects an accelerator that satisfies processing performance on the basis of the processing deadline of the input data determined by the data processing deadline determination unit 140 and a determination result of the determination unit (arithmetic device allocation determination unit 130) and distributes processing to the accelerator that has been selected.

As a result, [Requirement 1: Satisfaction of Responsiveness of Each Data] can be satisfied by the arithmetic device distribution unit 170 selecting an accelerator that satisfies performance and minimizes power consumption from the allocated accelerators on the basis of the processing deadline for each data, and offloading the selected accelerator. Therefore, since the accelerator state control device 100 allocates an optimal accelerator, power saving can be achieved.

The accelerator state control devices 100, 100A, and 100B (FIGS. 1 to 3) respectively include a latency recording unit (remote offload latency collection/recording unit 120) that measures and records a latency generated in remote offload between signal processing devices (server 200, remote offload server 210) equipped with accelerators, and the determination unit (arithmetic device allocation determination unit 130) obtains an amount of data corresponding to a processing deadline on the basis of the latency recorded in the latency recording unit and the performance of the accelerator recorded in the recording unit (arithmetic device performance collection/recording unit 110), and determines an accelerator that satisfies the performance on the basis of the data amount.

For example, the recording unit (arithmetic device performance collection/recording unit 110) records the access source host information, the access destination host information, and the latency (connection latency) in the latency table 310 illustrated in FIG. 5. When selecting an accelerator that meets the condition, the determination unit (arithmetic device allocation determination unit 130) refers to the latency table 310 for the remote accelerator, compares the latency recorded in advance with the performance of the accelerator, and allocates an optimal accelerator. Since the determination unit also determines the latency at the time of remote offloading in the parameter, it is possible to allocate a more optimal accelerator viewed from the entire system that cannot be measured only by the performance of the accelerator. As a result, [Requirement 2: Scalability] and [Requirement 1: Satisfaction of Responsiveness of Each Data] can be achieved in a higher dimension.

Accelerator state control systems 1000, 1000A, and 1000B (FIGS. 1 to 3) respectively include accelerator state control devices 100, 100A, and 100B (FIGS. 1 to 3) each of which includes a plurality of accelerators 12 having different processing performance, and controls a state of the accelerators when arithmetic processing is performed by offloading specific processing of an application 1 to the accelerator 12. Herein, the accelerator state control device 100 includes: when data in which different processing deadlines are mixed is input, a recording unit (arithmetic device performance collection/recording unit 110) that collects and records performance information of the accelerator 1; a prediction unit (traffic amount/processing deadline prediction unit 150) that predicts a traffic amount and a processing deadline after a lapse of a predetermined time from a ratio between current and past traffic amounts and a processing deadline; and a determination unit (arithmetic device allocation determination unit 130) that obtains a data amount corresponding to the processing deadline on the basis of the traffic amount and the processing deadline after the lapse of the predetermined time predicted by the prediction unit and the performance of the accelerator recorded in the recording unit, and determines an accelerator that satisfies the performance on the basis of the data amount.

As a result, the accelerator state control systems 1000, 1000A, and 1000B respectively include the accelerator state control devices 100, 100A, and 100B each of which includes the plurality of accelerators 12 having different processing performances and controls the state of the accelerator when the specific processing of the application 1 is offloaded to the accelerator 12 to perform the arithmetic processing. Therefore, it is possible to reduce the arithmetic operation resources to be used while ensuring responsiveness according to the variation in the data amount corresponding to each processing deadline.

Furthermore, among the respective types of processing described in the above embodiments and modifications, all or a part of the processing described as being automatically performed can be manually performed, or all or a part of the processing described as being manually performed can be automatically performed by a known method. In addition, processing procedures, control procedures, specific name, and information including various types of data and parameters illustrated in the specification and the drawings can be freely changed unless otherwise specified.

Further, each of the components of the respective devices illustrated in the drawings is functionally conceptual, and is not required to be physically configured as illustrated. In other words, a specific form of separation/integration of the devices is not limited to that illustrated in the drawings, and an entirety or a part thereof can be functionally or physically separated/integrated by any desired unit, in accordance with various kinds of loads, use conditions, and the like.

Further, some or all of the components, functions, processing units, processing means, and the like described above may be formed with hardware, such as being formed with an integrated circuit, for example. Also, the components, functions, and the like may be implemented by software for interpreting and executing a program for causing a processor to implement the functions. Information of a program, a table, a file or the like for implementing the functions can be retained in a recording device such as a memory, a hard disk, or a solid state drive (SSD), or in a recording medium such as an integrated circuit (IC) card, a secure digital (SD) card, or an optical disc.

### Reference Signs List

1 Application (APL)
10 Hardware
11 CPU
12, 12-1, 12-2, 12-3 Accelerator
13 Input/output unit
14 Remote offload input/output unit
20 Software
100, 100A, 100B Accelerator state control device
110 Arithmetic device performance collection/recording unit (recording unit)
120 Remote offload latency collection/recording unit (latency recording unit)
130 Arithmetic device allocation determination unit
140 Data processing deadline determination unit
150 Traffic amount/processing deadline prediction unit (prediction unit)
160 Function proxy execution unit
170 Arithmetic device distribution unit (distribution unit)
180 Remote offload unit
200 Server (server equipped with accelerator) (signal processing device)
210 Remote offload server (server equipped with accelerator) (signal processing device)
220 Antenna device
221 Antenna device data input/output unit
230 Subsequent-stage processing device
231 Subsequent-stage processing device data input/output unit
1000, 1000A, 1000B Accelerator state control system

1. An accelerator state control device that includes a plurality of accelerators having different processing performance, and controls a state of the accelerators when arithmetic processing is performed by offloading specific processing of an application to the accelerators, the accelerator state control device comprising:
when data in which different processing deadlines are mixed is input,
a recording unit configured to collect and record performance information of the accelerators; and
a processor configured to:
predict a traffic amount and a processing deadline after a lapse of a predetermined time from a ratio between current and past traffic amounts and a processing deadline; and
obtain a data amount corresponding to the processing deadline based on the traffic amount and the processing deadline after the lapse of the predetermined time predicted by the prediction unit and the performance of the accelerators recorded in the recording unit, and determine an accelerator that satisfies the performance based on the data amount.

2. The accelerator state control device according to claim 1, the processor further being configured to:
identify and provides notification of a processing deadline of input data; and
select an accelerator that satisfies processing performance based on the processing deadline of the input data determined by the data processing deadline determination unit and a determination result of the data processing deadline determination unit and distribute processing to the accelerator that has been selected.

3. The accelerator state control device according to claim 1, further comprising a latency recording unit configured to collect and record a latency generated in remote offload between signal processing devices equipped with the accelerator,
wherein the processor is configured to obtain a data amount corresponding to the processing deadline based on the latency recorded in the latency recording unit and the performance of the accelerators recorded in the recording unit, and determine an accelerator that satisfies the performance based on the data amount.

4. (canceled)

5. An accelerator state control method of an accelerator state control device that includes a plurality of accelerators having different processing performance, and is configured to control a state of the accelerators when arithmetic processing is performed by offloading specific processing of an application to the accelerators,
the accelerator state control method comprising steps of:
when data in which different processing deadlines are mixed is input,
collecting and recording performance information of the accelerators;
predicting, by a processor, a traffic amount and a processing deadline after a lapse of a predetermined time from a ratio between current and past traffic amounts and a processing deadline; and
obtaining, by the processor, a data amount corresponding to the processing deadline based on the traffic amount and the processing deadline after the lapse of the predetermined time that has been predicted and the performance of the accelerator that has been recorded, and determining the accelerator that satisfies the performance based on the data amount.

6. (canceled)

7. A non-transitory computer-readable storage medium storing a program for causing a computer, as an accelerator state control device that includes a plurality of accelerators having different processing performance, and is configured to control a state of the accelerators when arithmetic processing is performed by offloading specific processing of an application to the accelerators, to execute steps of:
when data in which different processing deadlines are mixed is input,
collecting and recording performance information of the accelerators;
predicting, by a processor, a traffic amount and a processing deadline after a lapse of a predetermined time from a ratio between current and past traffic amounts and a processing deadline; and
obtaining, by the processor, a data amount corresponding to the processing deadline based on the traffic amount and the processing deadline after the lapse of the predetermined time that has been predicted and the performance of the accelerator that has been recorded, and determining an accelerator that satisfies the performance based on the data amount.
